(19) United States
(12) Patent Application Publication
(10) Pub. No.: US 2026/0362378 A1
(43) Pub. Date: Nov. 12, 2026

(54) SYSTEM AND METHOD FOR DETERMINING LOCATION OF A USER EQUIPMENT (UE) IN A NETWORK ENVIRONMENT

(71) Applicant: JIO PLATFORMS LIMITED, Ahmedabad (IN)

(72) Inventors: Aayush BHATNAGAR, Navi Mumbai (IN); Vikash AGRAWAL, Navi Mumbai (IN); Omprakash KUSHWAH, Navi Mumbai (IN); Vikram LIMAN, Navi Mumbai (IN)

(73) Assignee: JIO PLATFORMS LIMITED, Ahmedabad (IN)

(21) Appl. No.: 19/515,101

(22) PCT Filed: Aug. 20, 2024
(86) PCT No.: PCT/IN2024/051517

§ 371 Date: Feb. 27, 2026

(30) Foreign Application Priority Data
Aug. 31, 2023 (IN) 202321058587

(51) Int. Cl. H04W 64/00; H04B 17/318; H04W 24/10; H04W 56/00

(52) U.S. Cl. CPC H04W 64/00; H04B 17/328; H04W 24/10; H04W 56/0045

(57) ABSTRACT

The present disclosure relates to a method and system for determining a location of a UE in a network environment The method encompasses: receiving, at a transceiver unit of a network node, a location request of the UE; processing, by a processing unit of the network node, a plurality of network parameters received from at least one network cell based on the location request; determining, by the processing unit of the network node, one or more locations of the UE based on each of the processed plurality of network parameters; calculating, by the processing unit of the network node, one or more distances between the determined one or more locations of UE and at least one network cell; calculating, by processing unit of the network node, a mean distance between UE and at least one network cell based on calculated one or more distances to determine location of UE.

### CROSS REFERENCE TO RELATED APPLICATIONS

This is the U.S. National Stage of International Application No. PCT/IN2024/051517, filed on Aug. 20, 2024, which was published in English under PCT Article 21(2), which in turn claims the benefit of India Application No. 202321058587, filed in India on Aug. 31, 2023. The applications are hereby incorporated herein in their entirety.

### FIELD OF TECHNOLOGY

The present disclosure generally relates to the field of wireless communication systems. More particularly, embodiments relate to methods and systems for determining location of a user equipment (UE) in a network environment.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not an admission of the prior art.

Wireless communication technology has rapidly evolved over the past few decades, with each generation bringing significant improvements and advancements. The first generation of wireless communication technology was based on analog technology and offered only voice services. However, with the advent of the second-generation (2G) technology, digital communication and data services became possible, and text messaging was introduced. 3G technology marked the introduction of high-speed internet access, mobile video calling, and location-based services. The fourth generation (4G) technology revolutionized wireless communication with faster data speeds, better network coverage, and improved security. Currently, the fifth generation (5G) technology is being deployed, promising even faster data speeds, low latency, and the ability to connect multiple devices simultaneously. With each generation, wireless communication technology has become more advanced, sophisticated, and capable of delivering more services to its users.

Accurate positioning of UE in a network environment has become increasingly critical due to the growing demand for location-based services, emergency services, and enhanced user experiences. Traditionally, positioning methods in wireless networks have relied on techniques such as Global Navigation Satellite System (GNSS), Cell ID-based positioning, and triangulation using signals from multiple network cells. However, these methods have inherent limitations, including a dependence on line-of-sight conditions, inconsistent levels of accuracy, and an increased power consumption in mobile devices.

Enhanced Cell ID (ECID) positioning is one of the methods used to determine the location of a UE in a cellular network. This method utilizes information from the network, such as the Reference Signal Received Power (RSRP) and Timing Advance (TA) values, to estimate the distance between the UE and the serving network cell (gNB). While ECID provides an improvement over basic Cell ID positioning by incorporating signal strength and timing information, it still faces challenges in achieving high levels of accuracy, especially in environments with dense network deployments and varied terrain.

### SUMMARY

This section is provided to introduce certain aspects of the present disclosure in a simplified form that are further described below in the detailed description. This summary is not intended to identify the key features or the scope of the claimed subject matter.

An aspect of the present disclosure may relate to a method for determining location of a UE in a network environment. The method includes receiving, at a transceiver unit of a network node a location request of the UE. The method further includes processing, by a processing unit of the network node, a plurality of network parameters received from at least one network cell based on the location request. The method further includes determining, by the processing unit of the network node, one or more locations of the UE based on each of the processed plurality of network parameters. The method further includes calculating, by the processing unit of the network node, one or more distances between the determined one or more locations of the UE and the at least one network cell. The method further includes calculating, by the processing unit of the network node, a mean distance between the UE and the at least one network cell based on the calculated one or more distances, to determine the location of the UE.

In an exemplary aspect of the present disclosure, the location request is received from an Access and Mobility Management Function (AMF).

In an exemplary aspect of the present disclosure, the at least one network cell includes a serving cell.

In an exemplary aspect of the present disclosure, the plurality of network parameters includes at least a Reference Signal Received Power (RSRP) value and a Timing Advance (TA2) value.

In an exemplary aspect of the present disclosure, the method further includes processing, by the processing unit of the network node, an Enhanced Cell ID (ECID) request for the UE and network cell measurements.

In an exemplary aspect of the present disclosure, the network node is a Location Management Function (LMF) node.

Another aspect of the present disclosure may relate to a system for determining location of a UE in a network environment. The system includes a transceiver unit, configured to receive, at a network node, a location request of the UE. The system further includes a processing unit connected to at least the transceiver unit. The processing unit is configured to process, at the network node, a plurality of network parameters received from at least one network cell based on the location request. The processing unit is further configured to determine, at the network node, one or more locations of the UE based on each of the processed plurality of network parameters. The processing unit is further configured to calculate, at the network node, one or more distances between the determined one or more locations of the UE and the at least one network cell. The processing unit is further configured to calculate, at the network node, a mean distance between the UE and the at least one network cell based on the calculated one or more distances, to determine the location of the UE.

Yet another aspect of the present disclosure may relate to a non-transitory computer readable storage medium, storing instructions for determining location of a UE in a network environment, the instructions including executable code which, when executed by one or more units of a system, causes: a transceiver unit, to receive, at a network node, a location request of the UE. The instructions when executed further causes the processing unit to process, at the network node, a plurality of network parameters received from at least one network cell based on the location request. The instructions when executed further causes the processing unit to determine, at the network node, one or more locations of the UE based on each of the processed plurality of network parameters. The instructions when executed further causes the processing unit to calculate one or more distances between the determined one or more locations of the UE and the at least one network cell. The instructions when executed further causes the processing unit to calculate, at the network node, a mean distance between the UE and the at least one network cell based on the calculated one or more distances, to determine the location of the UE.

OBJECTS Some of the objects of the present disclosure, which at least one embodiment disclosed herein satisfies are listed herein below.

It is an object of the disclosure to accurately determine position of a user equipment by utilizing serving cell information and neighbouring cell information.

Another object of the disclosure is to ensure better accuracy by utilizing RSRP and TA2 values.

Yet another object of the disclosure is for enhancement in the Location Mobility Function (LMF) where the Enhanced Cell ID (ECID) positioning method is used in order to get measurements related with gNodeBs.

It is yet another object of the disclosure for the LMF to receive RSRP and Timing Advance (TA2) values from gNB such that the LMF utilizes this information to calculate the distance between UE and gNB based on RSRP as well as TA2 separately.

It is also the object of the disclosure such that the LMF uses this information to find the mean distance between the UE and gNB.

### BRIEF DESCRIPTION OF THE DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Also, the embodiments shown in the figures are not to be construed as limiting the disclosure, but the possible variants of the method and system according to the disclosure are illustrated herein to highlight the advantages of the disclosure. It will be appreciated by those skilled in the art that disclosure of such drawings includes disclosure of electrical components or circuitry commonly used to implement such components.

FIG. 1 illustrates an exemplary block diagram representation of 5th generation core (5GC) network architecture.

FIG. 2 illustrates an exemplary block diagram of a computing device upon which the features of the present disclosure may be implemented in accordance with exemplary implementation of the present disclosure.

FIG. 3 illustrates an exemplary block diagram of a system for determining location of a UE in a network environment, in accordance with exemplary implementations of the present disclosure.

FIG. 4 illustrates a method flow diagram for determining location of a UE in a network environment, in accordance with exemplary implementations of the present disclosure.

FIG. 5 illustrates an exemplary process flow diagram for determining location of a UE in a network environment, in accordance with exemplary implementations of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments. It will be apparent, however, that embodiments may be practiced without these specific details. Several features described hereafter may each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “including” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a (Digital Signal Processing) DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from at least one of a transceiver unit, a processing unit, a storage unit, a detection unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein “interface” or “user interface” refers to a shared boundary across which two or more separate components of a system exchange information or data. The interface may also refer to a set of rules or protocols that define communication or interaction of one or more modules or one or more units with each other, which also includes the methods, functions, or procedures that may be called.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

As used herein the transceiver unit includes at least one receiver and at least one transmitter configured respectively for receiving and transmitting data, signals, information or a combination thereof between units/components within the system and/or connected with the system.

As discussed in the background section, the current known solutions have several shortcomings. The present disclosure aims to overcome the above-mentioned and other existing problems in this field of technology by providing a method and system for determining a location of a UE in a network environment.

As used herein, Reference Signal Received Power (RSRP) value refers to a measure of the received power level in cell network such as but not limited to cells of 4G network, 5G network or 6G network, but not limited to, other communication network may also be possible. The greater the RSRP value, the stronger the cellular signal.

As used herein, Timing Advance Type 2 (TA2) refers to a transmission method to control the Uplink Transmission timing of Individual UE. It is applicable to the following: physical uplink shared channel (PUSCH), physical uplink control channel (PUCCH) and sounding reference signal. The reason the timing advance (TA 2) method is useful is because it helps to ensure that transmission from all user equipment (UEs) are synchronised when received by the eNodeB/gNodeB. The TA value depends on the specific signal propagation delay for each UE, resulting in unique TA values for different UEs.

As used herein, the Enhanced Cell ID (ECID) request Enhanced Cell ID (E-CID) refers to positioning method which use additional UE and/or Evolved Universal Terrestrial Radio Access Network (E-UTRAN) and/or NG-RAN radio resource radio resource measurements and other measurements to improve the UE location estimate.

As used herein, Location Management Function (LMF) refers to a network entity responsible for determining the geographic position of User Equipment (UE) by processing location data, such as the Enhanced Cell ID (ECID), Reference Signal Received Power (RSRP), and Timing Advance (TA). The LMF coordinates with other network components to accurately estimate the UE's location, supporting services that require precise positioning information.

Hereinafter, exemplary embodiments will be described with reference to the accompanying drawings.

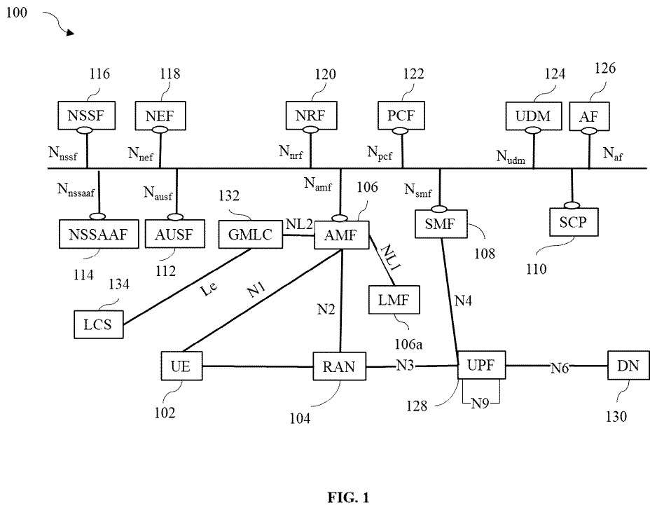

FIG. 1 illustrates an exemplary block diagram representation of 5th generation core (5GC) network architecture, in accordance with exemplary implementation of the present disclosure. As shown in FIG. 1, the 5GC network architecture [100] includes a UE [102], a radio access network (RAN) [104], an Access And Mobility Management Function (AMF) [106], a Location Management Function [106a], a Session Management Function (SMF) [108], a Service Communication Proxy (SCP) [110], an Authentication Server Function (AUSF) [112], a Network Slice Specific Authentication and Authorization Function (NSSAAF) [114], a Network Slice Selection Function (NSSF) [116], a Network Exposure Function (NEF) [118], a Network Repository Function (NRF) [120], a Policy Control Function (PCF) [122], a Unified Data Management (UDM) [124], an application function (AF) [126], a User Plane Function (UPF) [128], a data network (DN) [130], a Gateway Mobile Location Centre (GMLC) [132], Location service client [134] wherein all the components are assumed to be connected to each other in a manner as obvious to the person skilled in the art for implementing features of the present disclosure.

Radio Access Network (RAN) [104] is the part of a mobile telecommunications system that connects UE [102] to the core network (CN) and provides access to different types of networks (e.g., 5G network). It consists of radio base stations and the radio access technologies that enable wireless communication.

Access and Mobility Management Function (AMF) [106] is a 5G core network function responsible for managing access and mobility aspects, such as UE registration, connection, and reachability. It also handles mobility management procedures like handovers and paging.

Location Management Function (LMF) [106a] is a component within the 5G Core Network architecture which is responsible for managing the location of mobile devices within the network environment. Here, the mobile devices may include, without limitations, smartphones, tablets, IoT devices, within the mobile network. In an exemplary aspect, NL1 interface connects the LMF [106a] to the UE [102]. Specifically, the NL1 interface is configured to provide a connection between the LMF [106a] and the AMF [106], and via the AMF [106] to the UE [102].

Furthermore, the Location Management Function (LMF) [106a] supports functionalities, such as but without being limited to, obtaining downlink location measurements or a location estimate from the UE [102], obtaining uplink location measurements from the NG RAN, obtaining non-UE associated assistance data from the NG RAN, providing broadcast assistance data to UEs and forwarding associated ciphering keys to an AMF [106].

Session Management Function (SMF) [108] is a 5G core network function responsible for managing session-related aspects, such as establishing, modifying, and releasing sessions. It coordinates with the User Plane Function (UPF) for data forwarding and handles IP address allocation and QoS enforcement.

Service Communication Proxy (SCP) [110] is a network function in the 5G core network that facilitates communication between other network functions by providing a secure and efficient messaging service. It acts as a mediator for service-based interfaces.

Authentication Server Function (AUSF) [112] is a network function in the 5G core responsible for authenticating UEs during registration and providing security services. It generates and verifies authentication vectors and tokens.

Network Slice Specific Authentication and Authorization Function (NSSAAF) [114] is a network function that provides authentication and authorization services specific to network slices. It ensures that UEs can access only the slices for which they are authorized.

Network Slice Selection Function (NSSF) [116] is a network function responsible for selecting the appropriate network slice for a UE based on factors such as subscription, requested services, and network policies.

Network Exposure Function (NEF) [118] is a network function that exposes capabilities and services of the 5G network to external applications, enabling integration with third-party services and applications.

Network Repository Function (NRF) [120] is a network function that acts as a central repository for information about available network functions and services. It facilitates the discovery and dynamic registration of network functions.

Policy Control Function (PCF) [122] is a network function responsible for policy control decisions, such as QoS, charging, and access control, based on subscriber information and network policies.

Unified Data Management (UDM) [124] is a network function that centralizes the management of subscriber data, including authentication, authorization, and subscription information.

Application Function (AF) [126] is a network function that represents external applications interfacing with the 5G core network to access network capabilities and services.

User Plane Function (UPF) [128] is a network function responsible for handling user data traffic, including packet routing, forwarding, and QoS enforcement.

Data Network (DN) [130] refers to a network that provides data services to UE in a telecommunications system. The data services may include but are not limited to Internet services, private data network related services.

Gateway Mobile Location Centre (GMLC) [132] is the network entity in the 5G Core Network (5GC) supporting Location Services (LCS). Within the 5GC, the GMLC offers services to the AMF, GMLC and NEF. As used herein, Location services (LCS) are location-based services, with the goal of obtaining information of where the mobile is (location information). With the standardization of the format of the location information (latitude and longitude) the operators can offer different types of services. And these services can be used in several ways, as for pricing, legal requirements such as intercept, location services, emergency call services, among others.

Location services (LCS) client [134] is a software and/or hardware entity that interacts with a LCS Server for the purpose of obtaining location information for one or more Mobile Stations. LCS Clients subscribe to LCS in order to obtain location information. LCS Clients may or may not interact with human users. The LCS Client is responsible for formatting and presenting data and managing the user interface.

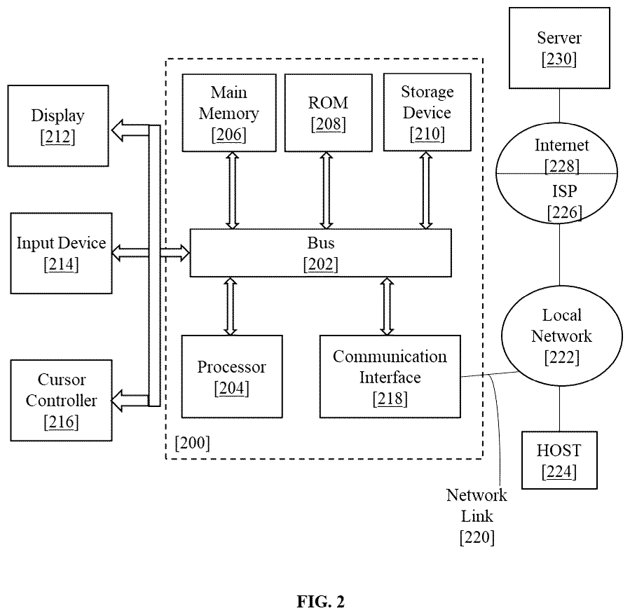

FIG. 2 illustrates an exemplary block diagram of a computing device [200] (also referred to herein as computer system [200]) upon which the features of the present disclosure may be implemented in accordance with exemplary implementation of the present disclosure. In an implementation, the computing device [200] may also implement a method for utilising the system. In another implementation, the computing device [200] itself implements the method for determining a location of a UE in a network environment using one or more units configured within the computing device [200], wherein said one or more units are capable of implementing the features as disclosed in the present disclosure.

The computing device [200] may include a bus [202] or other communication mechanism for communicating information, and a hardware processor [204] coupled with bus for processing information. The hardware processor [204] may be, for example, a general-purpose microprocessor. The computing device [200] may also include a main memory [206], such as a random-access memory (RAM), or other dynamic storage device, coupled to the bus for storing information and instructions to be executed by the processor [204]. The main memory [206] also may be used for storing temporary variables or other intermediate information during execution of the instructions to be executed by the processor [204]. Such instructions, when stored in non-transitory storage media accessible to the processor [204], render the computing device [200] into a special-purpose machine that is customized to perform the operations specified in the instructions. The computing device [200] further includes a read only memory (ROM) [208] or other static storage device coupled to the bus [202] for storing static information and instructions for the processor [204].

A storage device [210], such as a magnetic disk, optical disk, or solid-state drive is provided and coupled to the bus [202] for storing information and instructions. The computing device [200] may be coupled via the bus [202] to a display [212], such as a cathode ray tube (CRT), Liquid crystal Display (LCD), Light Emitting Diode (LED) display, Organic LED (OLED) display, etc. for displaying information to a computer user. An input device [214], including alphanumeric and other keys, touch screen input means, etc. may be coupled to the bus [202] for communicating information and command selections to the processor [204]. Another type of user input device may be a cursor controller [216], such as a mouse, a trackball, or cursor direction keys, for communicating direction information and command selections to the processor [204], and for controlling cursor movement on the display [212]. This input device typically has two degrees of freedom in two axes, a first axis (e.g., x) and a second axis (e.g., y), that allow the device to specify positions in a plane.

The computing device [200] may implement the techniques described herein using customized hard-wired logic, one or more ASICs or FPGAs, firmware and/or program logic which in combination with the computing device [200] causes or programs the computing device [200] to be a special-purpose machine. According to one implementation, the techniques herein are performed by the computing device [200] in response to the processor [204] executing one or more sequences of one or more instructions contained in the main memory [206]. Such instructions may be read into the main memory [206] from another storage medium, such as the storage device [210]. Execution of the sequences of instructions contained in the main memory [206] causes the processor [204] to perform the process steps described herein. In alternative implementations of the present disclosure, hard-wired circuitry may be used in place of or in combination with software instructions.

The computing device [200] also may include a communication interface [218] coupled to the bus [202]. The communication interface [218] provides a two-way data communication coupling to a network link [220] that is connected to a local network [222]. For example, the communication interface [218] may be an integrated services digital network (ISDN) card, cable modem, satellite modem, or a modem to provide a data communication connection to a corresponding type of telephone line. As another example, the communication interface [218] may be a local area network (LAN) card to provide a data communication connection to a compatible LAN. Wireless links may also be implemented. In any such implementation, the communication interface [218] sends and receives electrical, electromagnetic or optical signals that carry digital data streams representing various types of information.

The computing device [200] can send messages and receive data, including program code, through the network(s), the network link [220] and the communication interface [218]. In the Internet example, a server [230] might transmit a requested code for an application program through the Internet [228], the ISP [226], the local network [222], host [224] and the communication interface [218]. The received code may be executed by the processor [204] as it is received, and/or stored in the storage device [210], or other non-volatile storage for later execution.

The computing device [200] encompasses a wide range of electronic devices capable of processing data and performing computations. Examples of computing device [200] include, but are not limited only to, personal computers, laptops, tablets, smartphones, servers, and embedded systems. The devices may operate independently or as part of a network and can perform a variety of tasks such as data storage, retrieval, and analysis. Additionally, computing device [200] may include peripheral devices, such as monitors, keyboards, and printers, as well as integrated components within larger electronic systems, showcasing their versatility in various technological applications.

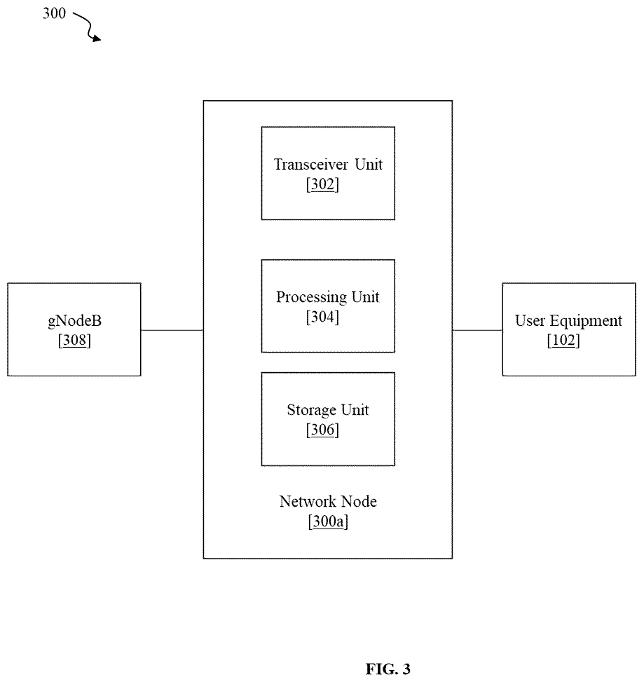

FIG. 3, an exemplary block diagram of a system [300] for determining a location of a UE in a network environment, is shown, in accordance with the exemplary implementations of the present disclosure. The system [300] includes at least one network node [300a], at least one transceiver unit [302], at least one UE [102], at least one processing unit [304], at least one storage unit [306] and at least one gNodeB [308]. Also, all of the components/units of the system [300] are assumed to be connected to each other unless otherwise indicated below. As shown in the figures all units shown within the system should also be assumed to be connected to each other. Also, in FIG. 3 only a few units are shown, however, the system [300] may include multiple such units or the system [300] may include any such numbers of said units, as required to implement the features of the present disclosure. Further, in an implementation, the system [300] may be present in a user device to implement the features of the present disclosure. The system [300] may be a part of the user device/or may be independent of but in communication with the user device (may also referred herein as a UE [102]). In another implementation, the system [300] may reside in a server or a network entity. In yet another implementation, the system [300] may reside partly in the server/network entity and partly in the user device.

The system [300] is configured for determining a location of a UE in a network environment, with the help of the interconnection between the components/units of the system [300].

The system includes a transceiver unit [302] which is configured to receive, at a network node [300a], a location request of the UE [102]. In an exemplary aspect, the transceiver unit [302] receives a location request of the user equipment for authorizing UE [102] to access network node services. In an exemplary aspect, the location request may include a UE identifier such as but not limited to an International Mobile Subscriber Identity (IMSI), International Mobile Equipment Identity (IMEI), Subscription Permanent Identifier (SUPI) etc. The network node [300a] is a LMF [106a]. In an exemplary aspect, LMF [106a] is responsible for managing the location of user equipment such as smartphones, tablets, IoT devices, within the mobile network. By tracking the current location of these devices, the LMF [106a] ensures that calls, data transfers, and other services are correctly routed to the appropriate location. In an exemplary aspect, the network node [300a] is connected to a gNodeB [308]. In another aspect, the network node [300a] receives measurement data from gNodeB [308] i.e. uplink measurements.

In an exemplary aspect, the LMF [106a] provides to the other network functions (NFs) the location of the UE [102] in the form of service such as, NImf_Location. As used herein, Nlmf_Location service allows an NF to request location determination (including current geodetic and local location) for a target UE [102] or to request periodic or triggered location for a target UE [102]. Furthermore, NImf_Location provides additional services such as DetermineLocation service to provide the UE [102] location information to a consumer NF; EventNotify service to notify the consumer NF of an event relating to a target UE; CancelLocation service to enable the consumer NF to cancel an ongoing periodic or triggered event for the target UE [102]; and LocationContextTransfer service to enable the consumer NF to transfer location context information for a periodic or a triggered event of the target UE [102], to the LMF [106a]. It may be appreciated that, while above description provides some exemplary services that the LMF provides, it is by no means a limit to location related service that the LMF may provide, and all of the potential functionalities of the LMF, as known by persons skilled in the art, may be considered to be within the scope of the present disclosure.

In an exemplary aspect, DetermineLocation service retrieves UE [102] location and further retrieves UE [102] location for 5G-MO-LR.

In an exemplary aspect, the location request is received from the AMF [106]. The location request is received at the transceiver unit [302] from the access and mobility management function (AMF) which is responsible for maintaining data of UE [102] location within the network, managing mobility tracking area updates of UE [102] and handling handovers between gNB network cells.

The system [300] further includes a processing unit [304] connected to at least the transceiver unit. The processing unit [304] is configured to process, at the network node [300a], a plurality of network parameters received from at least one network cell based on the location request. The network cell includes a serving cell. The network cells may be, for example, cells of 4G network, 5G network or 6G network. The network cells are also referred to herein as cell tower, radio access node, and base station. In an exemplary aspect, the processing unit [304] processes plurality of network parameters from at least one serving cell and at least one neighboring cell based on the location request that was received by the transceiver unit [302]. The plurality of network parameters includes at least a Reference Signal Received Power (RSRP) value and a Timing Advance (TA2) value. In an exemplary aspect, the processing unit [304] processes network parameters such as RSRP value that are received from at least one serving cell and at least one neighbour cell. The processing unit [304] at the network node [300a], then calculates the location of user equipment or an area where the UE [102] is located using the processed RSRP value. In an exemplary aspect, the processing unit [304] processes another network parameters such as the timing advance (TA2) value that are received from at least one serving cell and at least one neighbour cell. The LMF [106a] then calculates, using the processing unit [304] the location of user equipment or an area where the UE [102] is located.

For example, when the network node receives data from the UE, it might receive parameters like Reference Signal Received Power (RSRP) and Timing Advance (TA) from nearby network cells. To process these parameters, the processing unit [304] would analyse the RSRP to estimate how far the UE is located from each tower based on signal strength and use the TA to further refine the estimated location by calculating the time it takes for signals to travel between the UE and the tower. By combining these processed parameters, the system can more accurately pinpoint the UE's location.

The processing unit [304] is further configured to determine, at the network node [300a], one or more locations of the UE [102] based on each of the processed plurality of network parameters. In an exemplary aspect, the processing unit [304] determines the one or more location of the UE [102] using the processed network parameters such as RSRP value and TA2 value. The processed network parameters are calculated separately and later analysed to determine the exact location of the UE [102] in a network environment. After receiving and analysing data such as Reference Signal Received Power (RSRP) and Timing Advance (TA2) from the network's cells, the processing unit [304] utilizes these processed parameters to accurately estimate the UE's location within a specific area. For example, when the UE [102] is active within a network, the gNodeBs (gNBs) serving the area transmit RSRP and TA2 values to the network node [300a]. The processing unit [304] processes these parameters to calculate the distance from the UE [102] to each gNB. By using these distance estimates, the processing unit [304] can identify a location or an area where the UE [102] is likely situated. Further, if the RSRP indicates that the UE [102] is closer to a particular gNB and the TA2 value supports this, the processing unit [304] will determine that the UE [102] is within a specific radius of that gNB. It can further refine this location area by considering the parameters from neighbouring gNBs, cross-referencing the distance calculations to narrow down the possible location of the UE [102].

In an embodiment, the processing unit [304] can consider historical data or patterns in the movement of the UE to predict its current location area more accurately. For instance, if the UE has been moving in a certain direction and the processed parameters align with this movement, the processing unit might adjust the location area accordingly.

The processing unit [304] is further configured to calculate, at the network node [300a], one or more distances between the determined one or more locations of the UE [102] and the at least one network cell.

In an exemplary aspect, the processing unit [304] at the network node [300a], calculates one or more distances between the determined one or more locations of the UE [102] and the at least one network cell. The processing unit [304] after determining one or more locations of the UE [102] based on the processed plurality of network parameters like RSRP value and TA2 value, calculates corresponding distances from the UE [102] to the at least one network cell. In an embodiment, the at least one network cell is one that is serving the UE [102].

The processing unit [304] is further configured to calculate, at the network node [300a], a mean distance between the UE [102] and the at least one network cell based on the calculated one or more distances of the UE [102] from the processed plurality of network parameters like RSRP value and TA2 value. In an embodiment, the mean value of the one or more calculated distances is used to determine the location of the UE [102].

The processing unit [304] at network node [300a] calculates the mean distance between the UE [102] and multiple network cells to determine the UE's [102] location within a defined location area. In an exemplary aspect, the processing unit [304] after processing network parameters like RSRP value and TA2 value, calculates individual distances from the UE [102] to each serving cell and neighbour cell. Then, the processing unit [304] takes an average of these distances to obtain the mean distance to estimate the UE's [102] location within the location area of the network environment.

The processing unit [304] is further configured to process an Enhanced Cell ID (ECID) request for the UE [102] and network cell measurements. In an exemplary aspect, the processing unit [304] processes the ECID request by measuring/calculating a round-trip time (RTT) between the network cells and the UE [102]. Furthermore, the processing unit [304] processes network cell measurements that include one or more serving cell measurements and one or more neighbour cell measurements. Once the processing unit [304] has determined the location area of the UE based on processed network parameters such as Reference Signal Received Power (RSRP) and Timing Advance (TA2), it proceeds to calculate the mean distance between the UE [102] and the network cells that are contributing these parameters. The mean distance is essentially the average distance from the UE to the various gNodeBs (gNBs) or cells that have been considered in the initial location area determination. For example, if the UE [102] is within range of three different gNBs, and the processing unit [304] has calculated individual distances to each gNB based on the RSRP and TA2 values, the processing unit will then compute the mean of these distances. Suppose the distances to the three gNBs are 500 meters, 600 meters, and 550 meters. The processing unit calculates the mean distance as (500+600+550)/3=550 meters. This mean distance provides a more stable and accurate estimate of the UE's position, as it balances the variations in distance readings from different cells.

In an exemplary aspect, the processing unit [304] processes the Enhanced Cell ID (ECID) request that includes downlink E-CID positioning procedures to support E-CID related measurements obtained by the UE [102] and provided to the LMF [106a] using LPP. The term “downlink” is intended to indicate that from the LMF [106a] perspective the involved measurements are provided by the UE [102]; this set of procedures might also be considered as “UE [102]-assisted, LMF [106a]-based ECID”.

In an exemplary aspect, the processing unit [304] processes parameters in the form of information related to network cells such as but not limited only to LMF [106a] initiated location information transfer showing the location information transfer operations for the E-CID method when the procedure is initiated by the LMF [106a].

In an exemplary aspect, the processing unit [304] processes the information that may be signalled from UE [102] to the LMF [106a]. The information includes information such as but not limited only to Evolved Cell Global Identifier (ECGI)/Physical Cell ID, E-UTRA Reference signal received power (RSRP), E-UTRA Reference Signal Received Quality (RSRQ) and UE E-UTRA Rx−Tx time difference.

In an exemplary aspect, the processing unit [304] measurements related to E-CID measurements obtained by the NG-RAN node and provided to the LMF using NRPPa. The term “uplink” is intended to indicate that from the LMF point of view, the involved measurements are provided by the NG-RAN node; this set of procedures might also be considered as “NGRAN node-assisted E-CID”.

In an exemplary aspect, the processing unit [304] processes LMF [106a] initiated position measurement that shows the position measurement operations for the uplink E-CID method when the procedure is initiated by the LMF [106a].

In an exemplary aspect, the processing unit [304] processes E-CID measurement initiation procedure to allow the LMF [106a] to request the NG-RAN node to report ECID measurements used by LMF [106a] to compute the location of the UE [102].

In an exemplary aspect, the processing unit [304] processes E-CID measurement report procedure is for the NG-RAN node to provide the E-CID measurements for the UE [102] to the LMF [106a].

In an exemplary aspect, the processing unit [304] processes the E-CID measurement result information element to provide the E-CID measurement result.

In an exemplary aspect, the storage unit [306] stores data related to the calculated mean distance between the UE [102] that is further used to determine the accurate UE's [102] position in one or more locations.

The mean distance is useful in cases where the UE is equidistant from multiple cells or when signal conditions are such that no single cell provides a clear indication of proximity. By calculating the mean distance, the processing unit [304] mitigates the effect of any anomalies or outliers in the distance data from individual cells, leading to a more reliable location estimate. For example, if the UE [102] is moving through a network area with varying signal strengths, the processing unit [304] might calculate a mean distance using dynamic data. As the UE moves closer to or farther from certain cells, the mean distance calculation will adapt, providing a continuously updated and accurate location. This real-time adjustment is crucial in applications like navigation or emergency response, where the exact location of the UE must be tracked closely.

In an aspect, once the ECID data is processed by the network node, particularly the Location Management Function (LMF), it is utilized in several key steps to refine and finalize the UE's location.

After processing the ECID data, which includes parameters like Reference Signal Received Power (RSRP) and Timing Advance (TA2), the network node uses this information to refine the UE's location area. The ECID processing allows the system to pinpoint a more accurate location by combining signal strength and timing information. This refined location area is the foundation for subsequent calculations.

The processed ECID data is used to calculate the mean distance between the UE and the network cells (gNodeBs). The processing unit at the network node takes the individual distances derived from the ECID parameters and computes an average, or mean, distance. This step is essential for smoothing out anomalies and providing a balanced estimate of the UE's distance from the cells, which directly contributes to determining the UE's precise location.

With the refined location area and mean distance calculated using the processed ECID data, the system can perform more accurate triangulation. By using distances from multiple cells, the network node can triangulate the position of the UE within the refined location area. This step significantly improves the accuracy of the location estimate, particularly in dense urban environments where multiple cells contribute to the signal data.

As the UE moves, the ECID data is continuously updated and processed to reflect changes in signal strength and timing. The processed data is then used to dynamically adjust the location area and mean distance calculations, ensuring that the system can track the UE's position in real-time. This is particularly useful for applications that require continuous monitoring, such as navigation or emergency services.

The processed ECID data can also be integrated with other location determination methods, such as GPS or Wi-Fi-based positioning. By combining the ECID with these other methods, the system can cross-verify location estimates, increasing overall accuracy and reliability. For example, if GPS data is temporarily unavailable or unreliable due to signal blockages, the processed ECID data can provide a fallback method to maintain accurate location tracking.

Finally, all the information derived from the processed ECID data is synthesized to produce a final, precise location estimate for the UE. This estimate is then communicated to relevant network functions or applications, such as emergency services, location-based services, or mobility management systems.

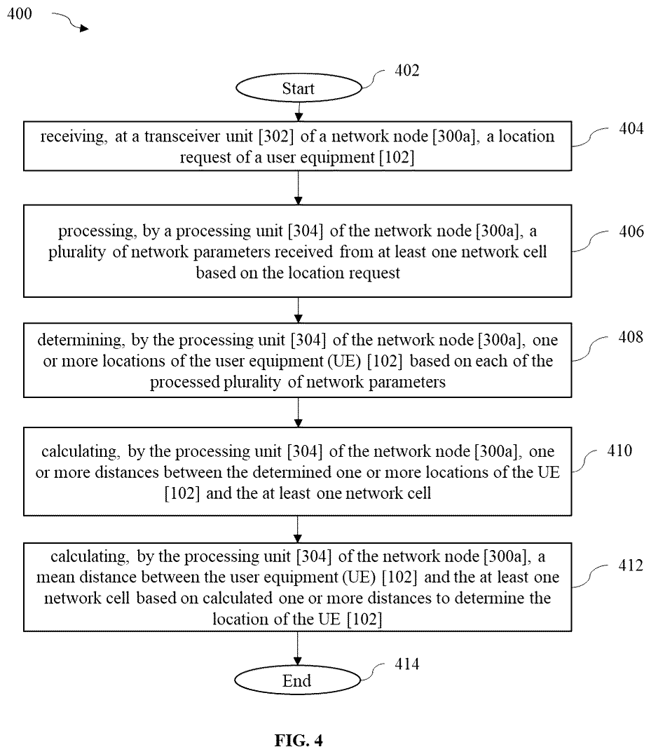

FIG. 4, an exemplary method flow diagram [400] for determining a location of a UE in a network environment in accordance with exemplary implementations of the present disclosure is shown. In an implementation the method [400] is performed by the system [300]. Further, in an implementation, the system [300] may be present in a server device to implement the features of the present disclosure. Also, as shown in FIG. 4, the method [400] starts at step [402].

At step 404, the method includes receiving, at a transceiver unit [302] of a network node [300a], a location request of the UE [102].

In an exemplary aspect, the transceiver unit [302] receives a location request of the user equipment for authorizing UE [102] to access network node services. In an exemplary aspect, the request may include a UE identifier such as but not limited to an International Mobile Subscriber Identity (IMSI), International Mobile Equipment Identity (IMEI), Subscription Permanent Identifier (SUPI) etc.

The network node [300a] is a LMF [106a]. In an exemplary aspect, LMF [106a] is responsible to manage the location of user equipment such as smartphones, tablets, IoT devices, within the mobile network. By tracking the current location of these devices, the LMF [106a] ensures that calls, data transfers, and other services are correctly routed to the appropriate location.

In an exemplary aspect, the location request is received from the AMF [106]. The location request is received at the transceiver unit [302] from the AMF [106] which is responsible for maintaining data of UE [102] location within the network, managing mobility tracking area updates of UE [102] and handling handovers between gNB network cells.

At step 406, the method [400] includes processing, by a processing unit [304] of the network node [300a], a plurality of network parameters received from at least one network cell based on the location request. The network cell includes a serving cell. In an exemplary aspect, the processing unit [304] processes plurality of network parameters from at least one serving cell and at least one neighboring cell based on the location request that was received by the transceiver unit [302].

In an exemplary aspect, the processing unit [304] processes another network parameters such as the timing advance (TA2) value that are received from at least one serving cell and at least one neighbour cell. The LMF [106a] then calculates, using the processing unit [304] the location of user equipment or an area where the UE [102] is located.

The processing unit [304] at the network node utilizes parameters like RSRP value and TA2 to estimate the UE's [102] location. By processing these parameters, the processing unit [304] at the network node may assess distance from the at least one serving cell and at least one neighbour cell, allowing for more accurate location determination.

For example, when the network node receives measurement data from the UE i.e. downlink measurements, it might receive parameters like Reference Signal Received Power (RSRP) and Timing Advance (TA) from nearby network cells. To process these parameters, the processing unit [304] would analyse the RSRP to estimate how far the UE is located from each tower based on signal strength and use the TA to further refine the estimated location by calculating the time it takes for signals to travel between the UE and the tower. By combining these processed parameters, the system can more accurately pinpoint the UE's location. In an exemplary aspect, network node [300a] receives measurement data from gNodeB [308] i.e. uplink measurements, it might receive parameters like Reference Signal Received Power (RSRP) and Timing Advance (TA) from nearby network cells.

At step 408, the method [400] includes determining, by a processing unit [304] of the network node [300a], one or more locations of the UE [102] based on each of the processed plurality of network parameters.

In an exemplary, the processing unit [304] determines the one or more location of the UE [102] using the processed network parameters such as RSRP value and TA2 value. These processed network parameters are calculated separately and later analysed to determine exact location of the UE [102] in a network environment. After receiving and analysing data such as Reference Signal Received Power (RSRP) and Timing Advance (TA2) from the network's cells, the processing unit [304] utilizes these processed parameters to accurately estimate the UE's location within a specific area. For example, when the UE [102] is active within a network, the gNodeBs (gNBs) serving the area transmit RSRP and TA2 values to the network node [300a]. The processing unit [304] processes these parameters to calculate the distance from the UE [102] to each gNB. By using these distance estimates, the processing unit [304] can identify a location area where the UE [102] is likely situated. Further, if the RSRP indicates that the UE [102] is closer to a particular gNB and the TA2 value supports this, the processing unit [304] will determine that the UE [102] is within a specific radius of that gNB. It can further refine this location area by considering the parameters from neighbouring gNBs, cross-referencing the distance calculations to narrow down the possible location of the UE [102].

In an embodiment, the processing unit [304] can consider historical data or patterns in the movement of the UE to predict its current location area more accurately. For instance, if the UE has been moving in a certain direction and the processed parameters align with this movement, the processing unit might adjust the location area accordingly.

At step 410, the method [400] includes calculating, by the processing unit [304] of the network node [300a], one or more distances between the determined one or more locations of the UE [102] and the at least one network cell.

In an exemplary aspect, the processing unit [304] at the network node [300a], calculates one or more distances between the determined one or more locations of the UE [102] and the at least one network cell. The processing unit [304] after determining one or more location of the UE [102] based on the processed plurality of network parameters like RSRP value and TA2 value, calculates individual distances from the UE [102] to at least one network cell such as but not limited only to each serving cell and neighbour cell.

At step 412, the method [400] includes calculating, by the processing unit [304] of the network node [300a], a mean distance between the UE [102] and the at least one network cell based on the calculated one or more distances to determine the location of the UE [102].

The processing unit [304] at network node [300a] calculates the mean distance between the UE [102] and multiple network cells to determine the UE's [102] location within a defined location area. In an exemplary aspect, the processing unit [304] after processing network parameters like RSRP value and TA2 value, calculates individual distances from the UE [102] to each serving cell and neighbour cell. Then, the processing unit [304] takes an average of these distances to obtain the mean distance to estimate the UE's [102] location within the location area of the network environment.

The method [400] further includes processing, by the processing unit [304] of the network node [300a], an Enhanced Cell ID (ECID) request for the UE [102] and network cell measurements. In an exemplary aspect, the processing unit [304] processes the ECID request by measuring/calculating a round-trip time (RTT) between the network cell and the UE [102]. Furthermore, the processing unit [304] processes network cell measurements that include one or more serving cell measurements and one or more neighbour cell measurements. Once the processing unit [304] has determined the location area of the UE based on processed network parameters such as Reference Signal Received Power (RSRP) and Timing Advance (TA2), it proceeds to calculate the mean distance between the UE [102] and the network cells that are contributing these parameters. The mean distance is essentially the average distance from the UE to the various gNodeBs (gNBs) or cells that have been considered in the initial location area determination. For example, if the UE [102] is within range of three different gNBs, and the processing unit [304] has calculated individual distances to each gNB based on the RSRP and TA2 values, the processing unit will then compute the mean of these distances. Suppose the distances to the three gNBs are 500 meters, 600 meters, and 550 meters. The processing unit calculates the mean distance as (500+600+550)/3=550 meters. This mean distance provides a more stable and accurate estimate of the UE's position, as it balances the variations in distance readings from different cells.

The method [400] further includes storing, by the storage unit [306] at the network node [300a], data related to the calculated mean distance between the UE [102] that is further used to determine the accurate UE's position in one or more locations.

The mean distance is useful in cases where the UE is equidistant from multiple cells or when signal conditions are such that no single cell provides a clear indication of proximity. By calculating the mean distance, the processing unit [304] mitigates the effect of any anomalies or outliers in the distance data from individual cells, leading to a more reliable location estimate. For example, if the UE [102] is moving through a network area with varying signal strengths, the processing unit [304] might calculate a mean distance using dynamic data. As the UE moves closer to or farther from certain cells, the mean distance calculation will adapt, providing a continuously updated and accurate location. This real-time adjustment is crucial in applications like navigation or emergency response, where the exact location of the UE must be tracked closely.

Thereafter, the method [400] terminates at step [414].

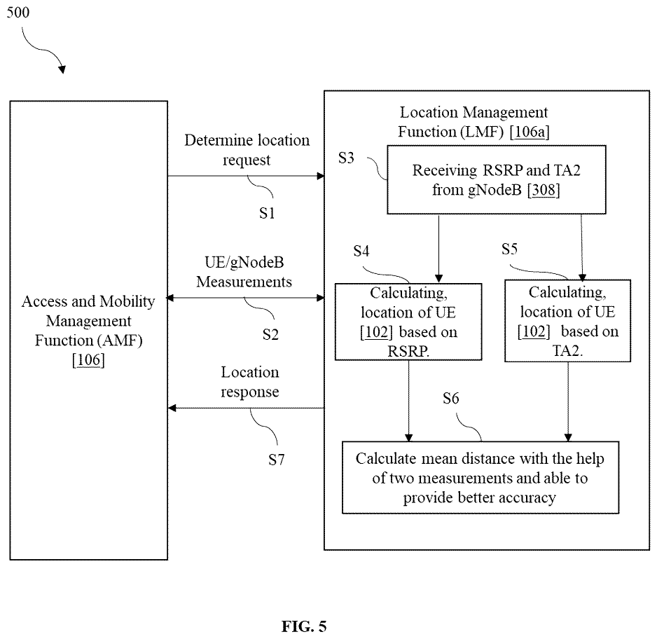

FIG. 5, an exemplary process [500] flow diagram for determining a location of a UE in a network environment, in accordance with exemplary embodiments is shown. The process is implemented on access and mobility management function (AMF) [106] and LMF [106a].

At step S1, the process [500] includes sending, by the AMF [106], a location request. In an exemplary aspect, the location request may include the Enhanced Cell ID (ECID) request for UE [102].

At step S2, the process [500] includes sending, by the AMF [106], and gNodeB [308] measurements i.e., uplink measurements. In an exemplary aspect, the AMF [106] is configured to provide the measurement about serving and neighboring gNodeBs [308]. In an exemplary aspect, gNodeB [308] measurements may include such as but not limited to Reference Signal Received Power (RSRP) and Timing advance 2 (TA2) measurement. In an exemplary aspect, the process [500] includes sending, by the AMF [106], and UE measurements, i.e., downlink measurements.

At step S3, the process [500] includes receiving, at a LMF [106a], the location request and gNB measurements (RSRP and TA2) in order to determine the said requests and measurements. The process further includes processing, at the LMF [106a], the Enhanced Cell ID (ECID) request for UE [102].

At step S4, the process [500] includes calculating, at the LMF [106a], the location of UE [102] or area of UE [102] based on Reference Signal Received Power (RSRP) received from the serving gNodeB.

At step S5, the process [500] includes calculating, at the LMF [106a], the location of UE [102] or area of UE [102] based on Timing Advance (TA2) received from the serving gNodeB [308].

At step S6, the process [500] includes calculating, at the LMF [106a], an accurate mean distance between UE and gNodeB [308], with the help of two measurements.

At step S7, the process [500] includes sending, by the LMF [106a], a location response back to the AMF [106]. In an exemplary aspect, the LMF [106a] sends a location response to the AMF [106] and the AMF [106] retrieves UE Location. This process allows a consumer NF to request the location information (geodetic location and, optionally, civic location) for a target UE or to activate periodic or triggered deferred location for a target UE. In an exemplary aspect, UE location includes location data various attributes such as but not limited only to location estimate, accuracy fulfilment indicator, age of location estimate, positioning data list, the GNSS positioning data list etc.

The present disclosure further discloses a user equipment (UE) [102]. The UE includes a processor, wherein the processor is configured to receive a location request from a network node [300a] for determining a location of the user equipment (UE) [102] in a network environment, wherein the location is determined based on receiving, at a transceiver unit [302] connected to at least the network node [300a], a location response from the UE [102]; processing, by a processing unit [304] connected to at least the transceiver unit [302], a plurality of network parameters received from at least one network cell based on the location response; determining, by the processing unit [304], one or more locations of the UE [102] based on each of the processed plurality of network parameters; calculating, by the processing unit [304], one or more distances between the determined one or more locations of the UE [102] and the at least one network cell; and calculating, by the processing unit [304], a mean distance between the UE [102] and the at least one network cell based on the calculated one or more distances to determine the location of the UE [102].

The present disclosure further discloses a non-transitory computer readable storage medium storing instructions for determining a location of a UE in a network environment, the instructions include executable code which, when executed by one or more units of a system, causes: a transceiver unit [302], to receive, at a network node [300a], a location request of the UE [102]. The instructions when executed further causes the processing unit [304] to process, at the network node [300a], a plurality of network parameters received from at least one network cell based on the location request. The instructions when executed further causes the processing unit [304] to determine, at the network node [300a], one or more location of the UE [102] based on each of the processed plurality of network parameters. The instructions when executed further causes the processing unit [304] to calculate, at the network node [300a], one or more distances between the determined one or more locations of the UE [102] and the at least one network cell. The instructions when executed further causes the processing unit [304] to calculate, at the network node [300a], a mean distance between the UE [102] and the at least one network cell based on the calculated one or more distances to determine the location of the UE [102].

As is evident from the above, the present disclosure provides a technically advanced solution for determining a location of a UE in a network environment. The present solution determines the positioning of the approximate location of UE while analysing Reference Signal Received Power (RSRP) value and Timing Advance (TA2) values from a serving cell information and the neighbouring cell information. Furthermore, the present solution provides a solution in which LMF is able to provide better location accuracy of the UE based on the RSRP values and TA2 values compared to traditional positioning algorithm.

Further, in accordance with the present disclosure, it is to be acknowledged that the functionality described for the various components/units can be implemented interchangeably. While specific embodiments may disclose a particular functionality of these units for clarity, it is recognized that various configurations and combinations thereof are within the scope of the disclosure. The functionality of specific units as disclosed in the disclosure should not be construed as limiting the scope of the present disclosure. Consequently, altemative arrangements and substitutions of units, provided they achieve the intended functionality described herein, are considered to be encompassed within the scope of the present disclosure.

While considerable emphasis has been placed herein on the disclosed implementations, it will be appreciated that many implementations can be made and that many changes can be made to the implementations without departing from the principles of the present disclosure. These and other changes in the implementations of the present disclosure will be apparent to those skilled in the art, whereby it is to be understood that the foregoing descriptive matter to be implemented is illustrative and non-limiting.

What is claimed is:

1. A method for determining a location of a user equipment (UE) in a network environment, comprising:
receiving, at a transceiver unit of a network node, a location request of the UE;
processing, by a processing unit of the network node, a plurality of network parameters received from at least one network cell based on the location request;
determining, by the processing unit of the network node, one or more locations of the UE based on each of the processed plurality of network parameters;
calculating, by the processing unit of the network node, one or more distances between the determined one or more locations of the UE and the at least one network cell; and
calculating, by the processing unit of the network node, a mean distance between the UE and the at least one network cell based on the calculated one or more distances to determine the location of the UE

2. The method of claim 1, wherein the location request is received from an Access and Mobility Management Function (AMF).

3. The method of claim 1, wherein the at least one network cell comprises a serving cell.

4. The method of claim 1, wherein the plurality of network parameters comprises at least a Reference Signal Received Power (RSRP) value and a Timing Advance (TA2) value.

5. The method of claim 1, wherein the method comprises processing, by the processing unit of the network node, an Enhanced Cell ID (ECID) request for the UE and network cell measurements.

6. The method of claim 1, wherein the network node is a Location Management Function (LMF) node.

7. A system for determining a location of a user equipment (UE) in a network environment, the system comprising:
a transceiver unit, configured to:
receive, at a network node, a location request of the UE;
a processing unit connected to at least the transceiver unit, the processing unit is configured to:
process, at the network node, a plurality of network parameters received from at least one network cell based on the location request;
determine, at the network node, one or more locations of the UE based on each of the processed plurality of network parameters; and
calculate, at the network node, one or more distances between the determined one or more locations of the UE and the at least one network cell;
calculate, at the network node, a mean distance between the UE and the at least one network cell based on the calculated one or more distances to determine the location of the UE.

8. The system of claim 7, wherein the location request is received from an Access and Mobility Management Function (AMF).

9. The system of claim 7, wherein the at least one network cell comprises a serving cell.

10. The system of claim 7, wherein the plurality of network parameters comprises at least a Reference Signal Received Power (RSRP) value and a Timing Advance (TA2) value.

11. The system of claim 7, wherein the processing unit is further configured to process an Enhanced Cell ID (ECID) request for the UE and network cell measurements.

12. The system of claim 7, wherein the network node is a Location Management Function (LMF) node.

13. The system of claim 7, wherein the system is communicably coupled to the User Equipment (UE) comprising a processor, wherein the processor is configured to:
transmit a location request to a network node for determining a location of a user equipment (UE) in a network environment, wherein for determining the location of the UE process steps comprise:
receiving, at a transceiver unit connected to at least the network node [300a], a location request of the UE;
processing, by a processing unit connected to at least the transceiver unit [302], a plurality of network parameters received from at least one network cell based on the location request;
determining, by the processing unit, one or more locations of the UE based on each of the processed plurality of network parameters;
calculating, by the processing unit, one or more distances between the determined one or more locations of the UE and the at least one network cell; and
calculating, by the processing unit, a mean distance between the UE and the at least one network cell based on the calculated one or more distances to determine the location of the UE.

14. A non-transitory computer-readable storage medium storing instruction for determining a location of a user equipment (UE) in a network environment, the storage medium comprising executable code which, when executed by one or more units of a system, causes:
a transceiver unit, to:
receive, at a network node, a location request of the UE;
a processing unit to:
process, at the network node, a plurality of network parameters received from at least one network cell based on the location request;
determine, at the network node, a location area of the UE based on each of the processed plurality of network parameters; and
calculate, at the network node, a mean distance between the UE and the at least one network cell based on the determined location area of the UE to determine the location of the UE.

15. The method of claim 1, wherein the location request may comprise a UE identifier such as but not limited to an International Mobile Subscriber Identity (IMSI), International Mobile Equipment Identity (IMEI), Subscription Permanent Identifier (SUPI).

16. The system of claim 7, wherein the location request may comprise a UE identifier such as but not limited to an International Mobile Subscriber Identity (IMSI), International Mobile Equipment Identity (IMEI), Subscription Permanent Identifier (SUPI).
